(19) United States
(12) Patent Application Publication
(10) Pub. No.: US 2014/0126431 A1
(43) Pub. Date: May 8, 2014

(54) INTERFACING WITH LOW-POWER AND LOSSY NETWORKS

(71) Applicant: CISCO TECHNOLOGY, INC., San Jose, CA (US)

(72) Inventors: Jonathan W. Hui, Belmont, CA (US); Wei Hong, Berkeley, CA (US); Jean-Philippe Vasseur, Saint Martin d'Uriage (FR)

(73) Assignee: Cisco Technology, Inc., San Jose, CA (US)

(21) Appl. No.: 13/669,122

(22) Filed: Nov. 5, 2012

(51) Int. Cl. H04L 5/14

(52) U.S. Cl. CPC H04L 5/14
USPC 370/277; 370/276

(57) ABSTRACT

In one embodiment, a client device determines when it is coupled to an IoT/LLN device to establish and enable an IP link between a headset interface on the client device and a signal interface on the IoT/LLN device. Once the IP link is established, a duplex data signal is transmitted between the client device and the IoT/LLN device, via the IP link.

### TECHNICAL FIELD

The present disclosure relates generally to computer networks, and, more particularly, to interfacing with computer networks.

### BACKGROUND

Low power and Lossy Networks (LLNs), e.g., sensor networks, have a myriad of applications, such as Smart Grid and Smart Cities. Various challenges are presented with LLNs, such as lossy links, low bandwidth, battery operation, low memory, processing capability, and/or interfacing with LLNs, etc.

One problem that confronts LLNs is communication challenges. For instance, LLNs communicate over a physical medium that is strongly affected by environmental conditions that change over time. Some examples include temporal changes in interference (e.g. other wireless networks or electrical appliances), physical obstruction (e.g. doors opening/closing or seasonal changes in foliage density of trees), and propagation characteristics of the physical media (e.g. temperature or humidity changes). The time scales of such temporal changes can range between milliseconds (e.g. transmissions from other transceivers) to months (e.g. seasonal changes of outdoor environment). Additionally, low-cost and low-power designs limit the capabilities of LLN transceivers. In particular, LLN transceivers typically provide low throughput. Furthermore, LLN transceivers typically support limited link margin, making the effects of interference and environmental changes visible to link and network protocols.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network and a directed acyclic graph (DAG);

FIG. 2 illustrates an example LLN network device/node;

FIG. 3 illustrates an example message;

FIG. 4 illustrates an example network;

FIG. 4 illustrates an example system level diagram for a client device; and

FIG. 6 illustrates an example process.

### DESCRIPTION OF EXAMPLE EMBODIMENTS

### Overview

In one embodiment, a client device determines when it is coupled to an IoT/LLN device to establish and enable an IP link between a headset interface on the client device and a signal interface on the IoT/LLN device. Once the IP link is established, a duplex data signal is transmitted between the client device and the IoT/LLN device, via the IP link. Operation of the IoT/LLN device may be monitored via a Graphical User Interface (GUI) provided on the client device.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, CPL G3, WPC and others. In addition, a Mobile Ad-Hoc Network (MANET) is a type of wireless ad-hoc network, which is generally considered a self-configuring network of mobile routes (and associated hosts) connected by wireless links, the union of which forms an arbitrary topology.

Smart object networks, such as sensor networks in particular, are a specific type of network consisting of spatially distributed autonomous devices such as sensors that cooperatively monitor physical or environmental conditions at different locations, such as, e.g., temperature, pressure, vibration, sound, radiation, motion, pollutants, etc. Other types of smart objects include actuators, e.g., objects responsible for turning on/off an engine or performing other actions. Sensor networks are typically wireless networks, though wired connections are also available. That is, in addition to one or more sensors, each sensor device (node) in a sensor network may generally be equipped with a radio transceiver or other communication port, a microcontroller, and an energy source, such as a battery. Generally, size and cost constraints on sensor nodes result in corresponding constraints on resources such as energy, memory, computational speed and bandwidth. Correspondingly, a reactive routing protocol may, though need not, be used in place of a proactive routing protocol for sensor networks.

In certain configurations, the sensors in a sensor network transmit their data to one or more centralized or distributed database management nodes that obtain the data for use with one or more associated applications. Alternatively (or in addition), certain sensor networks provide for mechanisms by which an interested subscriber (e.g., “sink”) may specifically request data from devices in the network. In a “push mode,” the sensors transmit their data to the sensor sink/subscriber without prompting, e.g., at a regular interval/frequency or in response to external triggers. Conversely, in a “pull mode,” the sensor sink may specifically request that the sensors (e.g., specific sensors or all sensors) transmit their current data (or take a measurement, and transmit that result) to the sensor sink. (Those skilled in the art will appreciate the benefits and shortcomings of each mode, and both apply to the techniques described herein.)

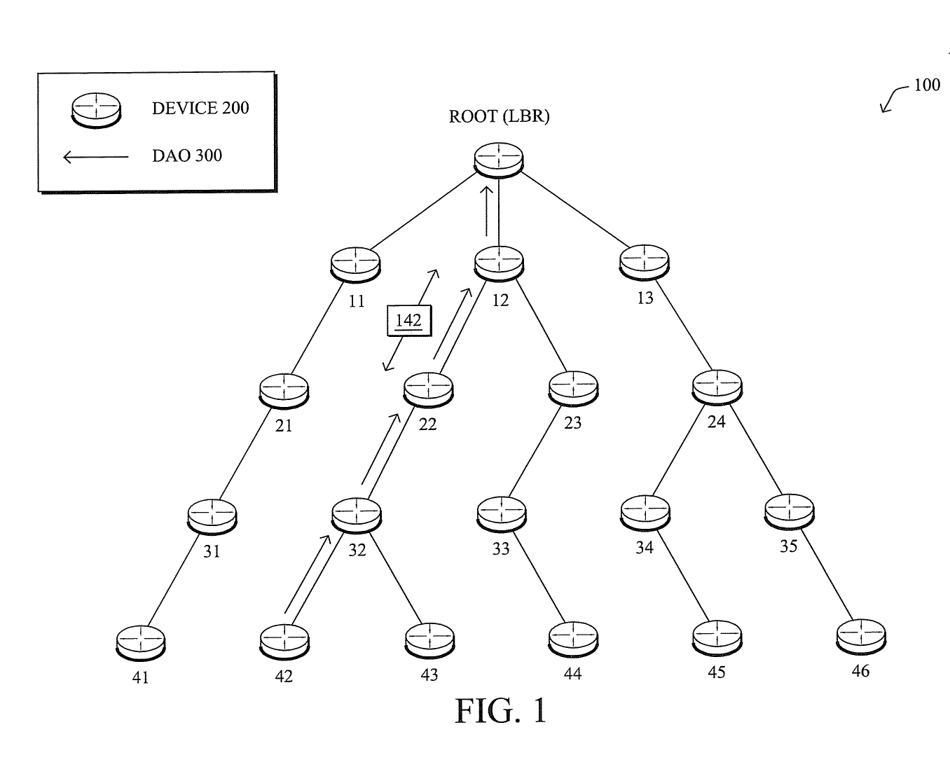

FIG. 1 is a schematic block diagram of an example computer network 100 illustratively comprising nodes/devices 200, such as, e.g., routers, sensors, computers, etc., interconnected by various methods of communication (e.g., and labeled as shown, “LBR,” “11,” “12,” . . . “46”). For instance, the links of the computer network may be wired links or may comprise a wireless communication medium, where certain nodes 200 of the network may be in communication with other nodes 200, e.g., based on distance, signal strength, current operational status, location, etc. Those skilled in the art will understand that any number of nodes, devices, links, etc. may be used in the computer network, and that the view shown herein is for simplicity. Illustratively, certain devices in the network may be more capable than others, such as those devices having larger memories, sustainable non-battery power supplies, etc., versus those devices having minimal memory, battery power, etc. For instance certain devices 200 may have no or limited memory capability. Also, one or more of the devices 200 may be considered “root nodes/devices” (or root capable devices) while one or more of the devices may also be considered “destination nodes/devices.”

Data packet messages 142 (e.g., traffic and/or messages sent between the devices/nodes) may be exchanged among the nodes/devices of the computer network 100 using predefined network communication protocols such as the Transmission Control Protocol/Internet Protocol (TCP/IP), User Datagram Protocol (UDP), Multi-Protocol Label Switching (MPLS), various proprietary protocols, etc. In this context, a protocol consists of a set of rules defining how the nodes interact with each other. In addition, packets within the network 100 may be transmitted in a different manner depending upon device capabilities, such as source routed packets.

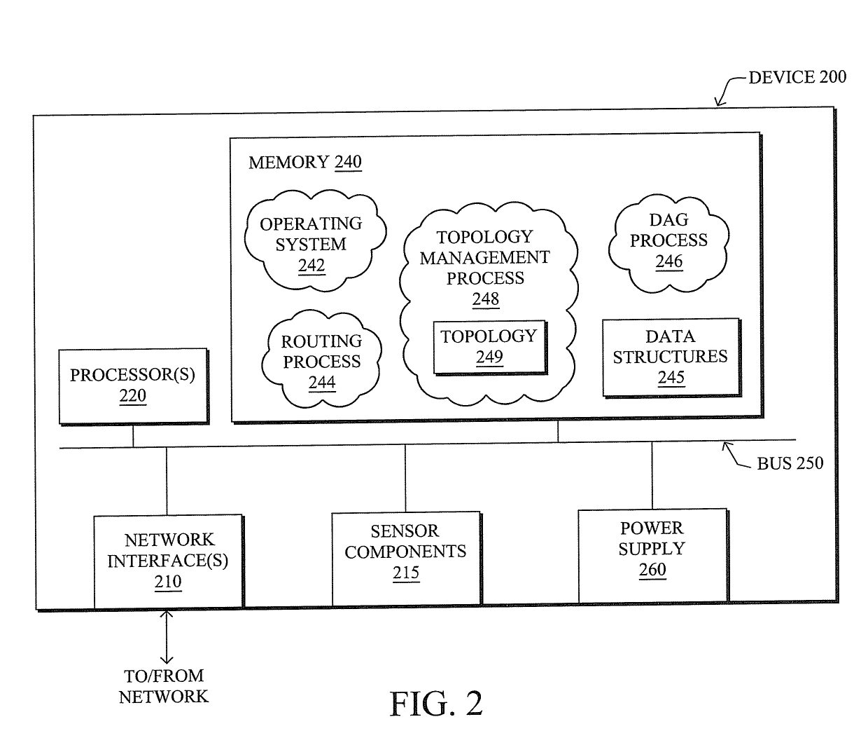

FIG. 2 is a schematic block diagram of an example node/device 200 that may be used with one or more embodiments described herein, e.g., as a root node or sensor. The device may comprise one or more network interfaces 210, one or more sensor components 215 (e.g., sensors, actuators, etc.), a power supply 260 (e.g., battery, plug-in, etc.), one or more processors 220 (e.g., 8-64 bit microcontrollers), and a memory 240 interconnected by a system bus 250. The network interface(s) 210 contain the mechanical, electrical, and signaling circuitry for communicating data over physical and/or wireless links coupled to the network 100. The network interface(s) may be configured to transmit and/or receive data using a variety of different communication protocols, including, inter alia, TCP/IP, UDP, wireless protocols (e.g., IEEE Std. 802.15.4, WiFi, Bluetooth (Registered trademark) ,), Ethernet, powerline communication (PLC) protocols, etc.

The memory 240 comprises a plurality of storage locations that are addressable by the processor(s) 220 and the network interface(s) 210 for storing software programs and data structures associated with the embodiments described herein. As noted above, certain devices may have limited memory or no memory (e.g., no memory for storage other than for programs/processes operating on the device). The processor(s) 220 may comprise necessary elements or logic adapted to execute the software programs and manipulate the data structures, such as routes or prefixes of a routing/forwarding table 245 (notably on capable devices only). An operating system 242, portions of which are typically resident in memory 240 and executed by the processor(s), functionally organizes the device by, inter alia, invoking operations in support of software processes and/or services executing on the device. These software processes and/or services may comprise routing process/services 244, which may include an illustrative directed acyclic graph (DAG) process 246. Also, for root devices (or other management devices), a topology management process 248 and associated stored topologies 249 may be present in memory 240, for use as described herein. It will be apparent to those skilled in the art that other processor and memory types, including various computer-readable media, may be used to store and execute program instructions pertaining to the techniques described herein. Also, while the description illustrates various processes, it is expressly contemplated that the various processes may be embodied as modules configured to operate in accordance with the techniques herein (e.g., according to the functionality of a similar process).

Routing process (services) 244 contains computer executable instructions executed by the processor(s) 220 to perform functions provided by one or more routing protocols, such as proactive or reactive routing protocols as will be understood by those skilled in the art. These functions may, on capable devices, be configured to manage routing/forwarding table 245 containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can direct the less capable devices exactly where to send the packets, and the less capable devices simply forward the packets as directed.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) A number of use cases require specifying a set of link and node metrics, some of them being dynamic, thus requiring specific smoothing functions to avoid routing instability, considerably draining bandwidth and energy;

4) Constraint-routing may be required by some applications, e.g., to establish routing paths that avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnects are constrained; LLN routers typically operate with constraints, e.g., processing power, memory, and/or energy (battery), and their interconnects are characterized by, illustratively, high loss rates, low data rates, and/or instability. The LLN may be sized with devices ranging from a few dozen to as many as thousands or even millions of LLN routers, and may support point-to-point traffic (between devices inside the LLN), point-to-multipoint traffic (from a central control point to a subset of devices inside the LLN) and multipoint-to-point traffic (from devices inside the LLN towards a central control point).

An example protocol specified in an Internet Engineering Task Force (IETF) Proposed Standard, Request for Comment (RFC) 6550, entitled “RPL: IPv6 Routing Protocol for Low Power and Lossy Networks” by Winter, et al. (March 2012), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc.

A DAG is a directed graph that represents a computer network, such as computer network 100, and that has the property that all edges are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, a sibling of a node within a DAG may be defined as any neighboring node which is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or, as used herein, one preferred parent.

DAGs may generally be built based on an Objective Function (OF). The role of the Objective Function is generally to specify rules on how to build the DAG (e.g. number of parents, backup parents, etc.).

In addition, one or more metrics/constraints may be advertised by the routing protocol to optimize the DAG. Also, the routing protocol allows for including an optional set of constraints to compute a constrained path, such as where if a link or a node does not satisfy a required constraint, it is “pruned” from the candidate list when computing the best path. (Alternatively, the constraints and metrics may be separated from the OF.) Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc., are considered “DAG parameters.”

Illustratively, example metrics used to select paths (e.g., preferred parents) may comprise cost, delay, latency, bandwidth, estimated transmission count (ETX), etc., while example constraints that may be placed on the route selection may comprise various reliability thresholds, restrictions on battery operation, multipath diversity, load balancing requirements, bandwidth requirements, transmission types (e.g., wired, wireless, etc.), and also a number of selected parents (e.g., single parent trees or multi-parent DAGs). Notably, an example for how routing metrics may be obtained may be found in an IETF RFC, entitled “Routing Metrics used for Path Calculation in Low Power and Lossy Networks” <RFC 6551> by Vasseur, et al. (March 2012 version). Further, an example OF (e.g., a default OF) may be found in an IETF RFC, entitled “RPL Objective Function 0” <RFC 6552> by Thubert (March 2012 version) .

Building of a DAG may utilize a discovery mechanism to build a logical representation of the network, and route dissemination to establish state within the network so that routers know how to forward packets toward their ultimate destinations. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going against the orientation of the edges within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward (UP) direction toward the root device. The DAG discovery reply (e.g., DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root which can, in turn, build the topology and locally compute downward routes to all nodes in the DODAG. Such nodes are then reachable using source routing techniques over regions of the DAG that are incapable of storing downward routing state.

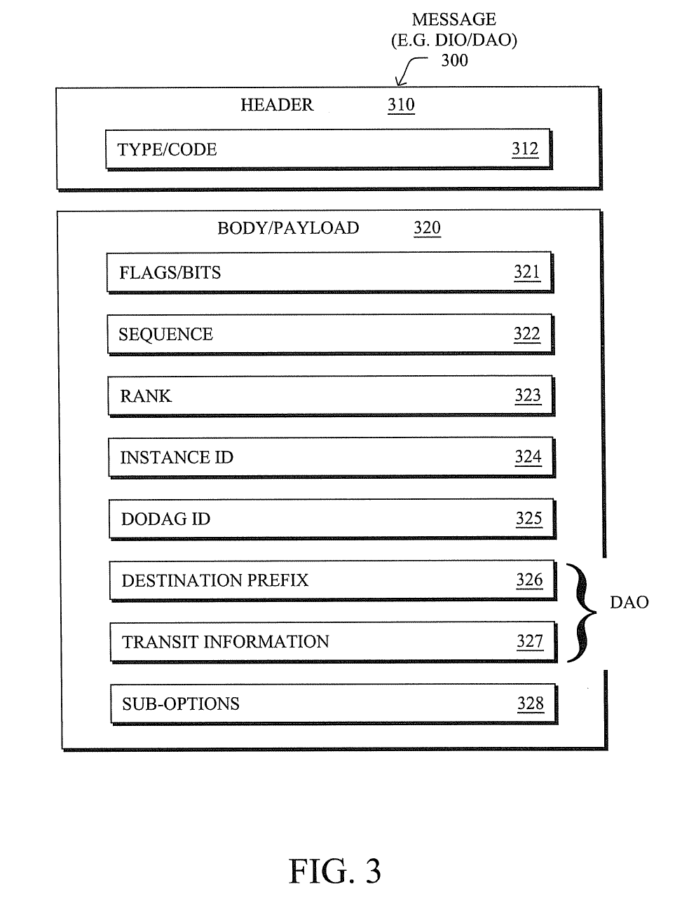

FIG. 3 illustrates an example DAO message 300 with a simplified control message format that may be used for discovery and route dissemination when building a DAG, e.g., as a DIO or DAO. Message 300 illustratively comprises a header 310 having one or more fields 312 that identify the type of message (e.g., a RPL control message) and a specific code indicating the specific type of message, e.g., a DIO or a DAO (or a DAG Information Solicitation). A body/payload 320 of the message may comprise a plurality of fields used to relay pertinent information. In particular, the fields may comprise various flags/bits 321, a sequence number 322, a rank value 323, an instance ID 324, a (DO)DAG ID 325, and other fields, each as may be appreciated in more detail by those skilled in the art. Further, for DAO messages, fields for a destination prefix 326 and a reverse route stack 327 may also be included. For either DIOs or DAOs, one or more additional sub-option fields 328 may be used to supply additional or custom information (such as, e.g., the VGF) within the message 300. For instance, an objective code point (OCP) sub-option field may be used within a DIO to carry codes specifying a particular objective function (OF) to be used for building the associated DAG.

With a generalized computer network 100 being described above, it is to now be appreciated that with the standardization and adoption of Internet Protocol based technologies such as 6LoWPAN and RPL, the usage of the Internet Protocol (IP) in LLNs is increasing. It is to be understood that by communicating via IP, devices 200 in LLNs are forming an extension of the Internet, commonly referred to as the Internet of Things (IoT).

LLNs and the IoT typically communicate using link technologies that are not typically found in more traditional devices, such as desktop computers, laptops, mobile phones, tablet computering devices, and other portable computering devices capable of coupling to a network, such as the Internet. It is noted that traditional Internet-based systems typically include Ethernet, WiFi, and/or Bluetooth and while desktop and laptop computer devices typically provide a numerous open communication interfaces (e.g. USB, IrDA, PCMCIA, microSD, USB On-The-Go (OTG)), these interfaces are not nearly as common (or open) on more ubiquitous devices, such as mobile smart phones or tablet computering devices. It is to be appreciated that such mobile smart phone devices and tablets computer devices are emerging as the predominant computing platform, overtaking the traditional desktop and laptop platforms. One reason being, mobile smart phone devices and tablet computer devices provide a convenient, and economical, computing platform. It is thus to be appreciated that the ubiquity of mobile smart phone devices and computer tablet devices offer convenient, and economical, computer platforms to drive additional computering services.

With regards to at least mobile smart phone devices and computer tablet devices it is noted the only actual open and ubiquitous interface on such devices is the headset interface. Typically such a headset interface is configured as a 3.5 mm phono jack/plug used to output audio to headphones and receive input from a microphone. For instance, such a headset interface provided on APPLE IPHONES and IPAD computer devices, ANDROID OS driven smart phone devices and computer tablet devices, and in addition to many other smart phone devices and computer tablet devices. It is noted that while the Apple iPhone does provide a serial port, it does so through a proprietary connector and its operating system (e.g., iOS) does not expose open APIs to utilize the serial port.

IoT devices typically communicate using link technologies that are not utilized in the aforesaid portable computer devices, particularly smart phone devices and computer tablets. For example, many IoT devices communicate using IEEE 802.15.4, Z-Wave, IEEE P1901.2, etc. None of these interfaces are available on a smart phone device or a computer tablet. While it may be feasible to add other wireless technologies to IoT devices (e.g. Bluetooth or WiFi) to interface with mobile phones and tablets, doing so significantly increases the cost and power consumption of the IoT devices.

It is noted a challenge with using and managing IoT devices is their lack of a user interface—in many cases they may provide only a single LED. While there has been attempts to build dedicated “field tools” that include the necessary LLN link interface(s), along with the software, such field tools are typically expensive and are difficult to make ubiquitous. Building such tools on already ubiquitous devices would significantly lower the cost of development and significantly lower the barrier to customer adoption.

Accordingly, in conjunction with certain illustrated embodiments, described below is a method, system and device for providing a standard IP link between an LLN device and portable computer device (e.g., a smart phone device, computer tablet device and the like) hereinafter referred to as a “client device” using a standard interface (e.g., a 3.5 mm headset interface), provided on the client device.

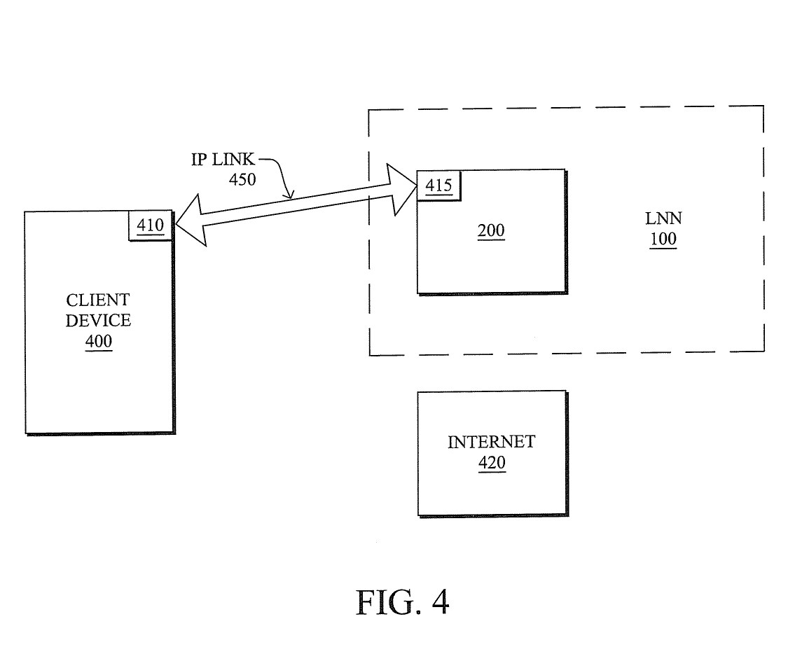

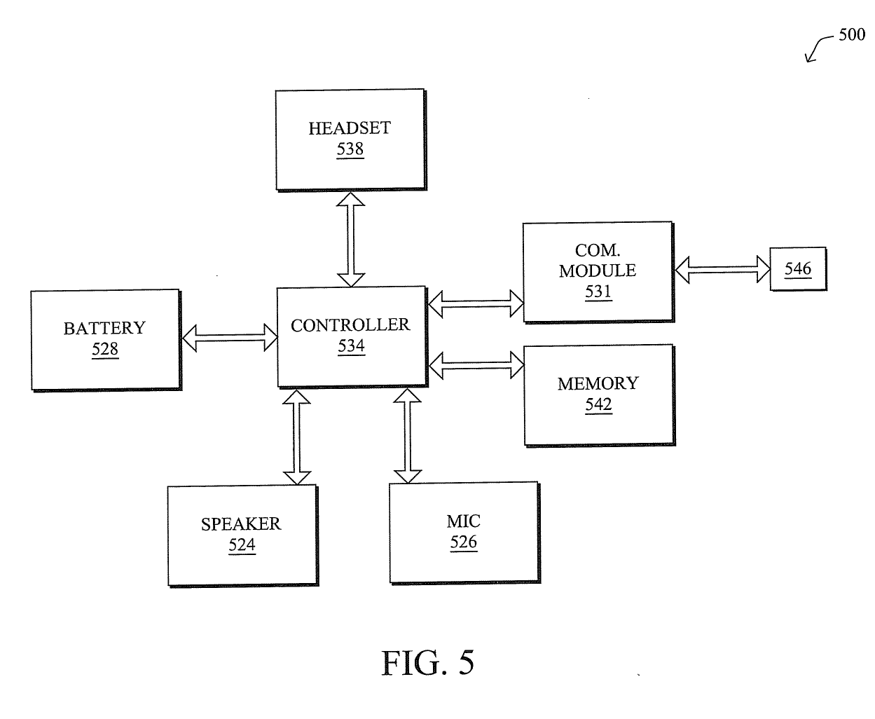

With reference now to FIG. 4, illustrated is a system level diagram depicting a client device 400 interfacing with an LLN device 200 coupled in an LLN network 100 in accordance with certain illustrated embodiments. As mentioned above, client device 400 is a computing device such as a personal computer device having a headset interface (e.g., a 3.5 mm headset phone/jack/plug capable of providing duplex communication). It is to be understood and appreciated that client device 400 may consist of a myriad of personal computing devices, such as smart phone handsets, laptop and tablet computer devices, personal digital assistant devices, or a combination thereof.

It is to be understood client device 400 includes a software application for receiving content and interacting with its headset interface 410 and is preferably capable of wireless connection to the Internet 420. In an illustrated embodiment, the client device 400 connects to the Internet 420 via a Wireless Access Protocol WAP gateway. A variety of wireless communication network interfaces may be utilized to communicate with a WAP gateway. For example, client device 400 may preferably be a TCP/IP enabled device and therefore addressable as a network device. Protocols for exchanging data via TCP/IP networks are well known and need not be discussed herein. The TCP/IP network could be the Internet or a private intranet. However, client device 400 is not restricted to TCP/IP networks. Although reference is only made to a single client device 400 herein for convenience, it should be understood that a plurality of client devices 400 for interfacing with a LLN 100, as described herein, are to be encompassed by the certain illustrated embodiments as described herein.

FIG. 5 illustrates a simplified block diagram of the components of the client device 400. Client device 400 includes a controller 544 such as a microprocessor and a memory 542 executing software to implement functionality as described herein. Although illustrated separately, memory 542 may integrated with controller 544. Controller 544 may further include an analog-to-digital (A/D) converter and a digital-to-analog (D/A) converter. The controller 544 receives input from headset user interface 538 and manages data received from microphone 526 and sent to speaker 524. The headset controller 544 further interacts with wireless communication module 531 to transmit and receive signals between the client device 400 and the Internet 420. Additionally, client device 400 may be further configured to interact with a telephony network (not shown) employing comparable communication modules or a WAP gateway. Wireless communication module 531 includes an antenna 546. Battery 528 provides power to the various components of the client device 400.

With the components of certain embodiments described above, description of their implementation for providing an IP link between a client device 400 and a LLN device 200, using a standard headset interface (e.g. the 3.5 mm analog audio interface) is herein described with reference to certain illustrated embodiments. It is to be appreciated that an advantage for using such a standard headset interface is it's an open interface currently found on many, if not most, commercially available client devices 400.

One such illustrated embodiment for implementing an IP link 450 uses a Point-to-Point Protocol (PPP) (e.g., RFC 1661, 1662, etc.) to form the IP link 450. It is to be appreciated, using standard modulation techniques, a client device 400 (e.g., a mobile/smart phone device) and an external device are capable of communicating digital data. By using an IP link 450, it is now feasible to communicate and manage IoT/LLN devices 200 using a client device 400 (e.g., a mobile smart phone or tablet PC). Thus, by implementing all of the application-specific functionality using ubiquitous application protocols (e.g. HTTP/TCP), this obviates the need for application-specific code on the client device 400.

To couple the client device 400 to an IoT/LLN device(s) 200, a corded wireless coupling is preferably used to provide duplex data communication over the IP link 450 wherein such a corded coupling preferably utilizes a plug member provided on the end points of the corded member configured and adapted to couple with the aforesaid headset interfaces (410, 415) provided on the client device 400 and the IoT/LLN device(s) 200. For instance, such a plug member may consist of a 3.5 mm male plug member adapted to receive and interact with a 3.5 mm female configured phone/jack member interface provided on each client device 400 and IoT/LLN device(s) 200. It also to be appreciated that certain illustrated embodiments may utilize a wireless connection to establish an IP link 450 between the client device 400 and the IoT/LLN device(s) 200. For instance, a dongle member preferably plugs into each headset interface (410, 415) provided on the client device 400 and the IoT/LLN device(s) 200 configured for wireless communication with one another using standard protocols for doing so, including for instance, a Bluetooth wireless link being established. It is to be further understood the dongle member may be adapted and configured to interact directly with an LLN interface provided on an IoT/LLN device (e.g., IEEE 802.15.4 or P1901.2).

Another component of the certain illustrated embodiments is that once a coupling (via preferably an IP link) is established between a client device 400 and an IoT/LLN device(s) 200, the client device 400 preferably uses a “connection detection” mechanism/software implemented on the client device 400 to automatically enable/disable the PPP link 450. It is to be appreciated that the vast majority of commercially available client devices are enabled to detect when a headset has been plugged into its headset interface. Thus, a PPP driver for the headset interface in the client device 400 is preferably utilized to automatically determine when to initiate the PPP Link Control Protocol (LCP) to initiate the link. Additionally, it may also preferably use the signal to determine when to mark the link as non-operational. Yet another component of the certain illustrated embodiments is to utilize PPP's option negotiations on a client device 400 to determine a type of IoT/LLN device(s) 200 coupled to the client device 400 and/or the services provided by the IoT/LLN device(s) 200. Therefore, the client device 400 having its software interfacing with the IoT/LLN device(s) 200 can automatically configure itself for the particular IoT/LLN device 200 it is coupled with.

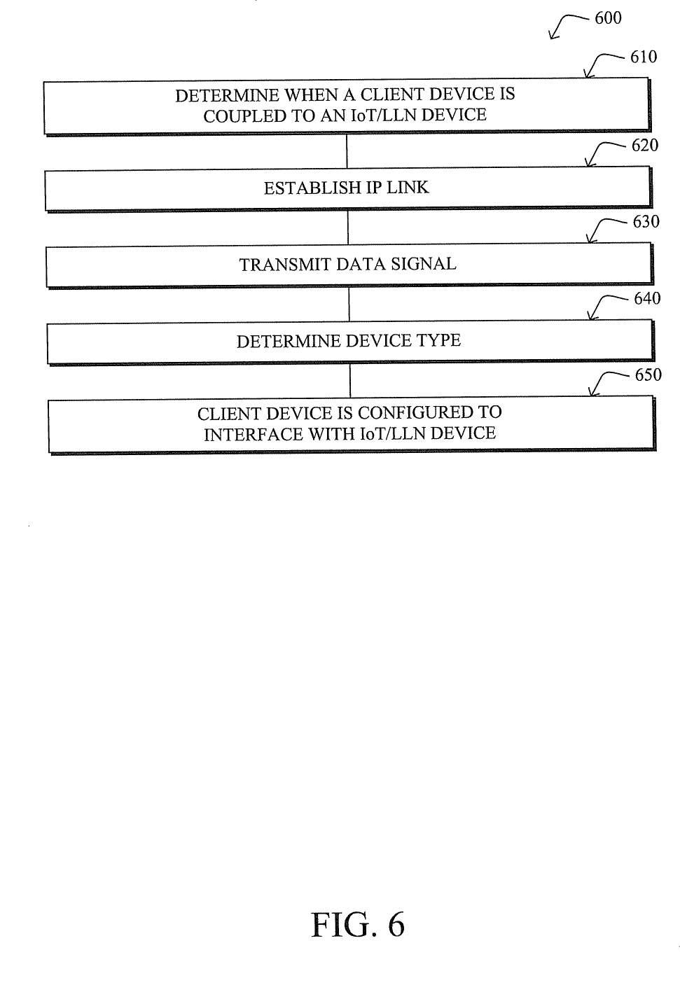

With components of certain illustrated embodiments being described above, and with reference now to process 600 of FIG. 6, a method of operation will now be described. Starting at step 610, the client device 400 may be configured and operable to determine when it is coupled to an IoT/LLN device 200. When it is determined it is coupled to an IoT/LLN device 200, the client device 400 then establishes and enables an IP link 450 preferably between a headset interface 410 on a client device 400 and a signal interface (e.g., a headset interface) 415 on an IoT/LLN device 200 in a LLN 100 (step 620). For instance, the IP link 450 may consist of a PPP data link using an RFC 1661 standard. Once the IP link 450 is established, a duplex data signal is transmitted between the client device 400 and the IoT/LLN device 200, via the IP link 450 (step 630). It is to be appreciated that once the IP link is established, operation of the IoT/LLN device 200 may be monitored via a Graphical User Interface (GUI) provided on the client device 400. The client device 400 may also initiate Hypertext Transfer Protocol (HTTP) link with another device to establish a wireless link via TCP/IP network.

The client device 400 may be further be configured and operable to determine a device type for the IoT/LLN device 200 it is coupled with (step 640). And once the device type is determined, the client device 400 may configure itself to interface with the determined device type for the IoT/LLN device 200 (step 650).

With certain illustrated embodiments being described above, it is to be appreciated that what has been described is the use of the headset jack on client devices (e.g., smart phone devices) to establish an IP link for providing a full-duplex digital link that supports PPP and IP with an IoT/LLN device in an LLN. Therefore, an advantage of the certain illustrated embodiments is the utilization of a headset interface to provide an economical method for a client device to interact directly with an IoT/LLN device, preferably using the GUI of the client device. It is to be appreciated, communicating over a separate physical interface (alternative to a low-power RF, PLC, etc.) provides a completely separate and reliable interface.

While certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide an IP link between a client device and an IoT/LLN device, it is to be understood that various other adaptations and modifications may be made within the spirit and scope of the embodiments herein. For example, the embodiments have been shown and described herein with relation to LLN networks, and, in particular, the RPL protocol. However, the embodiments in their broader sense are not as limited, and may, in fact, be used with other types of networks and/or protocols.

The foregoing description has been directed to specific illustrated embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof Accordingly this description is to be taken only by way of example and not to otherwise limit the scope of the embodiments herein. Therefore, it is the object of the appended claims to cover all such variations and modifications as come within the true spirit and scope of the embodiments herein.

1. A method, comprising:
establishing an Internet Protocol (IP) link between a headset interface on a client device and a signal interface on a device in a Low-Power and Lossy Network (LLN) wherein the client device is external of the LLN; and
transmitting, between the client device and the LLN device, a duplex data signal via the IP link.

2. A method as recited in claim 1, wherein the IP link is a Point-to-Point Protocol (PPP) data link.

3. A method as recited in claim 2, wherein the PPP data link uses a RFC 1661 standard.

4. A method as recited in claim 1, wherein the communicating data step further includes detecting operation of the LLN device via a Graphical User Interface (GUI) provided on the client device.

5. A method as recited in claim 1, wherein the signal interface of the LLN device is a headset interface.

6. A method as recited in claim 1, wherein each headset interface is configured to couple with a 3.5 mm coupling member.

7. A method as recited in claim 1, wherein the IP link between the client device and the LLN device is a wireless link.

8. A method as recited in claim 1, wherein the client device is configured to initiate a Hypertext Transfer Protocol (HTTP) link with another client device to establish data communication therebetween.

9. A method as recited in claim 8, wherein the client device comprises a portable computer device.

10. A method as recited in claim 9, wherein the portable computer device comprises a mobile phone, smart phone, personal digital assistant or tablet device.

11. A method as recited in claim 1, further comprising the steps:
determining in the client device when it is coupled to the LLN device; and
enabling the IP link when it is determined the client device is coupled to the LLN device.

12. A method as recited in claim 11, further comprising the steps:
determining a device type for the LLN device that is coupled to the client device; and
configuring the client device to interface with the LLN device contingent upon the determined LLN device type.

13. An apparatus, comprising:
one or more network interfaces to communicate with a Wide Area Network (WAN);
a headset interface adapted to send and receive duplex data signals;
a processor coupled to the network interfaces and the headset interface, the processor adapted to execute one or more processes; and
a memory configured to store a process executable by the processor, the process when executed operable to:
establish an Internet Protocol (IP) link between the headset interface and a signal interface on device coupled in a Low-Power and Lossy Network (LLN); and
transmit, between the apparatus and the LLN device, a duplex data signal via the IP link.

14. An apparatus as recited in claim 13, wherein the IP link is a Point-to-Point Protocol (PPP) data link.

15. An apparatus as recited in claim 13, wherein the signal interface of the LLN device is a headset interface.

16. An apparatus as recited in claim 15, wherein each headset interface is configured to couple with a 3.5 mm coupling member.

17. An apparatus as recited in claim 13, wherein the process when executed is further operable to initiate a Hypertext Transfer Protocol (HTTP) link with another apparatus using the WAN to establish data communication therebetween.

18. An apparatus as recited in claim 17, wherein the apparatus is a mobile phone, smart phone, personal digital assistant or tablet device.

19. An apparatus recited in claim 13, wherein the process when executed is further operable to:
determine when the apparatus is coupled to the LLN device; and
enable the IP link when it is determined the apparatus is coupled to the LLN device.

20. An apparatus recited in claim 19, wherein the process when executed is further operable to:
determine a device type for the LLN device that is coupled to the apparatus; and
configure the apparatus to interface with the LLN device contingent upon the determined LLN device type.

21. A tangible, non-transitory, computer-readable media having software encoded thereon, the software when executed by a processor operable to:
establish an Internet Protocol (IP) link between a headset interface on a client device and a signal interface on a device in a Low-Power and Lossy Network (LLN) wherein the client device is external of the LLN; and
transmit, between the client device and the LLN device, a duplex data signal via the IP link.

22. The computer-readable media as in claim 21, wherein the software when executed is further operable to:
determine when the client device is coupled to the LLN device; and
enable the IP link when it is determined the client device is coupled to the LLN device.

23. The computer-readable media as in claim 22, wherein the software when executed is further operable to:
determine a device type for the LLN device that is coupled to the client device; and
configure the client device to interface with the LLN device contingent upon the determined LLN device type.
